(19) United States
(12) Patent Application Publication
(10) Pub. No.: US 2006/0096411 A1
(43) Pub. Date: May 11, 2006

(54) AUTOMOTIVE VEHICLE TRANSMISSION VENT ASSEMBLY

(75) Inventors: Daniel Aldrich, Stockbridge, MI (US); Greg Long, Plymouth, MI (US); John Hayter JR., Canton, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 10/904,358

(22) Filed: Nov. 5, 2004

(51) Int. Cl. F16H 57/04

(52) U.S. Cl. 74/606 A

(57) ABSTRACT

A dry cavity and transmission vent assembly for an automotive vehicle transmission defining a region within a portion of a transmission housing in which rotary elements of the transmission are located whereby air and transmission fluid in an air and transmission fluid mixture are separated, the separated transmission fluid being drained from the dry cavity as air in the mixture is vented to atmosphere.

### BACKGROUND OF THE INVENTION

1. Field of the Invention

The invention relates to automotive power transmission mechanisms and to a vent assembly for venting the interior of the transmission.

2. Background Art

Power transmission mechanisms for automotive vehicles include rotary elements, including gearing elements and selectively engageable clutches and brakes to establish and disestablish multiple torque flow paths from a torque input member to a torque output member. The rotary elements usually are mounted within a transmission housing on an axis corresponding to a torque input shaft axis or a torque output shaft axis. The rotary elements are lubricated with transmission fluid, which is distributed throughout the transmission under pressure developed by a transmission pump connected driveably to a power source, such as an internal combustion engine in the vehicle powertrain. A transmission fluid sump is situated at the lower region of the transmission housing to receive transmission fluid dispersed throughout the rotating elements of the transmission. The sump typically includes an oil filter disposed at the fluid flow inlet side of the transmission pump.

Rotation of the rotary elements of the transmission creates a mixture of transmission fluid and air under an internal positive pressure. The internal pressure is a result of a dynamic interaction of the rotating internal transmission elements, the transmission fluid and air mixture and the non-rotating components of the transmission. The positive pressure is released to atmosphere, but this should be done without releasing transmission fluid.

To accommodate the release of the pressure build up of the air and transmission fluid mixture in the transmission housing, it is general design practice to provide a vent hole at a so-called dry location within the transmission housing. A simple “jiggle cap” may be put in the transmission housing, the vent hole communicating with the dry location. Other examples of vent or air breather designs are disclosed in U.S. Pat. Nos. 4,794,942 and 6,015,444.

The design of the '444 patent includes a fitting that extends radially outward from the transmission housing. A cap is secured to the fitting, thereby defining a chamber that contains filter material to encourage coalescence of transmission fluid, which is returned to the transmission.

Dry locations within a transmission housing are difficult to locate and are expensive to create in cast metal components. Typically, the transmission housing is a casting. The fluid dynamics of transmission fluid inside the transmission, together with the internal air pressure created by rotating elements within the transmission, tend to cause the transmission fluid to be vented through the vent hole, thus creating a fluid leak.

U.S. Pat. No. 6,058,969 discloses another design for venting an automotive transmission housing. That design comprises a breather port located in a transmission tailshaft extension housing, which is located relatively remotely with respect to the rotating elements of the transmission. The breather port establishes a transmission fluid vapor flow path to a vent tube located on the exterior of the transmission housing. The tube extends to a forward transmission housing portion situated in a so-called transmission bell housing. In the case of an automatic transmission having a hydrokinetic torque converter, the bell housing would surround the torque converter.

In the case of a manual transmission with a selectively engageable neutral clutch, the rotating neutral clutch elements would be located within the bell housing. The bell housing itself, for either an automatic transmission or a manual transmission, would be connected to an engine block for an internal combustion engine.

### SUMMARY OF THE INVENTION

It is an objective of the invention to provide a transmission vent assembly that does not require the use of a vent tube of the kind disclosed in the '969 patent and that does not establish a so-called leak flow path characteristic of other transmission vent assemblies of the kind shown, for example, in the '942 patent and the '696 patent. The invention includes a dry cavity that can be installed within the transmission at a location that is relatively isolated from rotary elements of the transmission. The cavity will prohibit transfer of a fluid and air mixture, or vapor, under pressure created within the transmission. It avoids external discharge of transmission fluid.

The vent assembly of the invention includes a vent hole in a transmission housing, which communicates with a dry cavity placed within the transmission. The dry cavity will prevent fluid in a fluid and air mixture from being discharged to the atmosphere. It includes a vent hole that will permit air in the transmission fluid and air mixture to reach the atmosphere by way of a hole in the external transmission housing. The dry cavity also has a drain opening or port to allow fluid in the dry cavity to drain back into the transmission sump.

A short vent tube can be used to connect the vent hole in the transmission housing to the transmission bell housing region, which is under atmospheric pressure. The strategic design of the dry cavity will permit fluid within the fluid component of the vapor created inside the transmission housing to coalesce and separate from air within the transmission housing. The fluid is allowed to return to the interior of the transmission, while the air component of the fluid vapor is allowed to exit to the atmosphere through the short vent tube at the exterior of the transmission housing.

Typically, a transmission of the kind commonly used in contemporary vehicles has a center bearing support wall for supporting a torque input shaft and torque input elements of the gearing and rotary friction elements. The dry cavity may be situated directly adjacent the transmission center bearing support wall. It may be shaped to avoid interference with the rotary transmission elements while creating a sufficiently large cavity to effect separation of air and transmission fluid.

The dry cavity may be formed of a heat molded material, such as nylon. It may consist of two separable moldable parts, each being formed with a separate molding die. The dry cavity can be shaped to facilitate its retention within an opening of generally similar shape in a transmission center bearing support wall.

### BRIEF DESCRIPTION OF THE DRAWINGS

FIG. 1 is a cross-sectional view of a torque converter automatic transmission of the kind used in contemporary automotive vehicles, including the dry cavity of the invention;

FIG. 2 is a plan view of one molded part of the dry cavity mounted on the bearing support wall of the transmission of FIG. 1;

FIG. 2a shows a side view of the dry cavity part of FIG. 2;

FIG. 3 is a plan view of a second molded part of the dry cavity seen in FIG. 1;

FIG. 3a is a side view of the second molded part of the dry cavity seen in FIG. 1;

FIG. 4 is a plan view of the dry cavity element of FIGS. 2-3a mounted in the bearing support wall seen in FIG. 1, the vantage point being at the front of the transmission of FIG. 1; and

FIG. 5 is a view similar to FIG. 4 as seen from a vantage point at the rearward end of the transmission of FIG. 1.

### DETAILED DESCRIPTION OF THE PREFERRED EMBODIMENT(S)

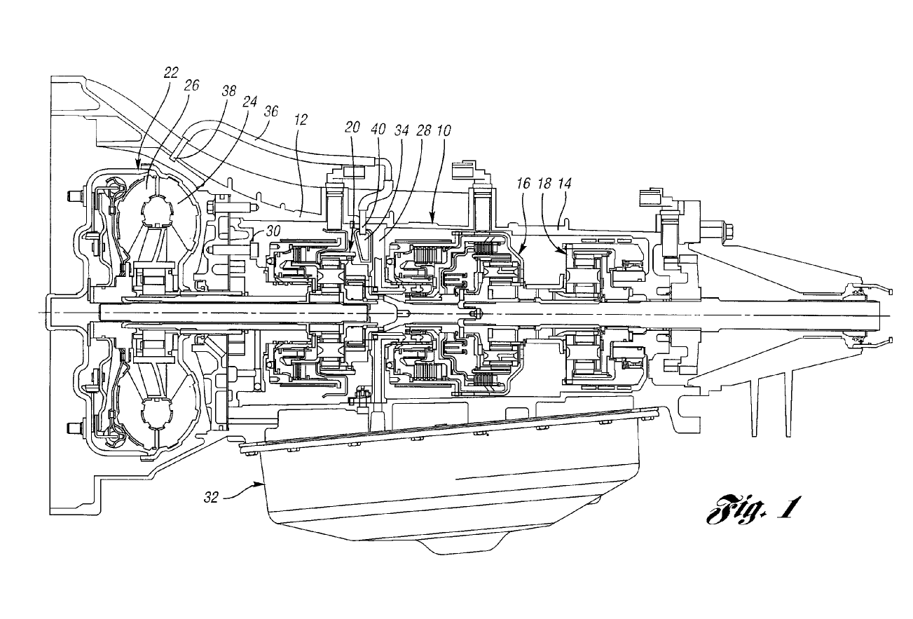

In FIG. 1, a transmission housing is indicated generally by reference numeral 10. It includes a forward portion 12 and a rearward portion 14. Automatic transmission planetary gear units 16 and 18 are rotatably mounted within the transmission housing portion 14 about the axis of a transmission output shaft.

In the transmission of FIG. 1, a third simple planetary gear unit 20 is situated within the forward portion 12 of the transmission housing. A hydrokinetic torque converter 22 is situated in a bell-shaped part (bell housing) of the forward housing portion 12. The torque converter 22 includes a hydrokinetic impeller, which is connected to an internal combustion engine crankshaft, and a turbine 26, which is connected to a turbine shaft that delivers torque to the planetary gear unit 20. Both the forward housing portion 12 and the rearward housing portion 14 enclose rotary friction elements for establishing multiple gear ratios.

A positive displacement pump 30 is connected driveably to the impeller 24. It delivers pressurized fluid through pressure distributor passages and lubrication oil passages throughout the transmission assembly. Fluid is returned under gravity to a transmission sump 32 secured to the lower side of the transmission housing 10.

A dry cavity 34 is secured to the forward side of a bearing support wall 28, as seen in FIG. 1. It communicates with a vent tube 36, one end of which is received within the transmission housing portion 12 and within the interior of the dry cavity 34. An opposite end of the tube 36 communicates with a fitting 38 that extends within the bell housing of the transmission forward housing portion 12.

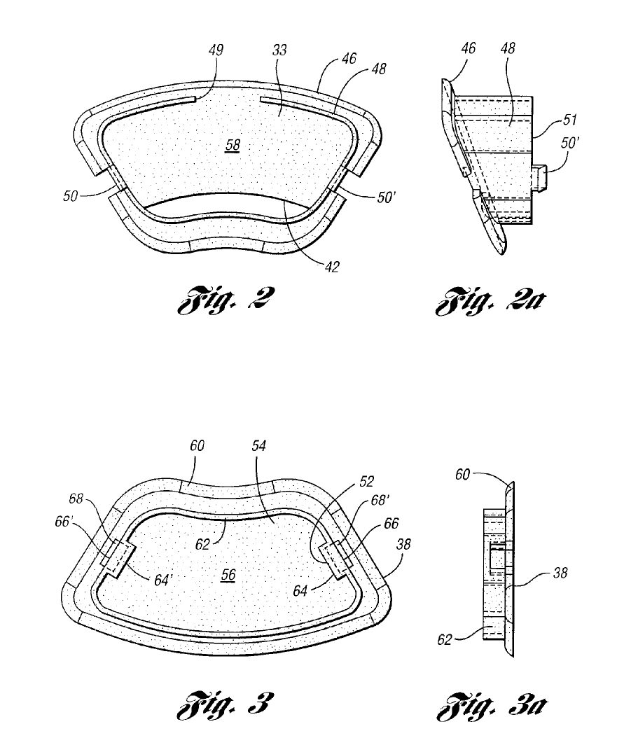

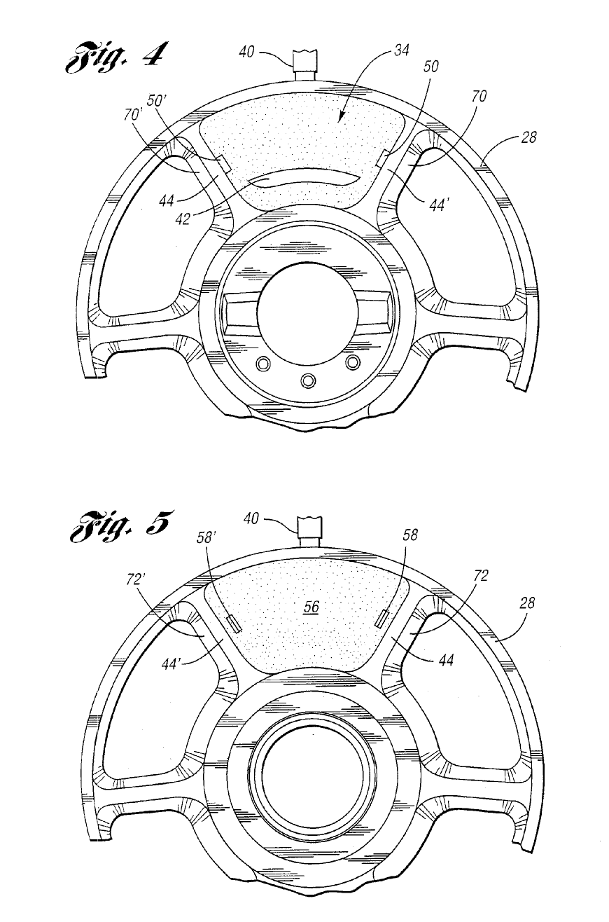

As seen in FIGS. 4 and 5, the bearing support wall 28 includes generally radially extending arms 44 and 44′. The dry cavity 34 is shaped so that it can be received within an opening in the bearing support wall 28 between adjacent radial arms 44 and 44′. The dry cavity includes a first part 33, which preferably is molded from a thermoplastic material such as nylon. Part 33, seen in FIG. 2, comprises a wall 58 with a margin 46 that registers with the internal margin of the opening between radial arms 44 and 44′. An opening 42 in the wall 58 is situated at a radially inward location.

A side wall 48 encircles the wall 58 and the lower margin of the opening 42. Wall 48 has an opening 49 through which a fitting 40, seen at FIG. 1, extends.

As seen in the side view of FIG. 2a, the wall 48 has a variable depth, the right-hand margin 51 being generally in a radial plane and the wall 58 being in a plane that is angularly disposed with reference to a radial reference plane, not shown. The right-hand margin 51 includes a retainer tab, as shown at 50′ in FIG. 2a. A corresponding tab 50 is formed on the left margin of the wall 58, as seen in FIG. 2.

FIG. 3 shows a companion part 54 of the dry cavity. It comprises a wall 56, which defines a cover for the part shown in FIGS. 2 and 2a. A margin 60 registers with the periphery of the bearing support wall opening between the support wall radial arms 44 and 44′, as seen in FIGS. 4 and 5. The wall 56 has an upstanding portion 62 encircling the part 54 adjacent the margin 60. The portion 62 has a boss on each lateral side of the wall 56, as shown at 64 and 64′. Each boss has a lip, as shown at 66 and 66′ respectively, which register with the tabs 50′ and 50, shown in FIG. 2.

When the portion 62 is inserted within the wall 48 of FIG. 2a, the tabs 50′ and 50 are received within slots 68′ and 68, seen in FIG. 3. As the tabs are inserted within the slots 68′ and 68, the companion parts of the dry cavity are snapped together to form an assembly thereby locking the dry cavity in assembled relationship with respect to the bearing support wall as the margins 46, seen in FIG. 2 and at 60 in FIG. 3, engage opposed sides of the radial elements 44′ and 44 of the bearing support wall.

The radial arms 44 and 44′ have radial edges, which engage the peripheries of the dry cavity parts so that when the companion parts of the vent assembly are snapped into place, they are secured within the opening between the radial arms 44 and 44′. The edges of the radial arms 44 and 44′ are shown in FIG. 4 at 70 and 70′. Corresponding edges are shown in FIG. 5 at 72 and 72′ on the opposite side of the bearing support wall.

The fitting 40, shown in FIG. 1, registers with the opening 49 in the dry cavity part seen in FIG. 2. A suitable fitting can be provided to establish a connection between the fitting and the interior of the dry cavity. The fitting (not shown) will establish a generally leak-free flow path between the interior of the dry cavity and the fitting 40 as, round fitting, which is round, enters the non-circular opening 49, which may be generally rectangular.

During operation of the transmission with the dry vent installed, any internal pressure created by the fluid dynamics of the air and lubricating oil mixture inside the transmission will tend to force the mixture through the vent opening 42. The dry cavity, into which the transmission fluid and air mixture enters, will permit the fluid to separate from the air. It then will drain through the opening 42 into the transmission, whereby it may be returned to the transmission sump and recirculated through the filter in the pump intake side of the transmission pump 30. The air may vent to the atmosphere after fluid in the fluid and air mist or vapor has been separated in liquid form from the air.

Although the dry cavity of the embodiment disclosed herein may be formed of moldable nylon material or any other material that can withstand the environmental conditions within the transmission housing, the dry cavity may instead be cast into a removable transmission component, such as the bearing support wall seen in FIG. 1.

The embodiment of the invention disclosed in this application includes a vent tube 36 to direct air expelled from the dry vent cavity into the hydrokinetic torque converter bell housing, but the air may be discharged to the atmosphere through a flow path that does not include an external tube.

An embodiment of the invention has been disclosed, but it will be apparent to persons skilled in the art that modifications may be made without departing from the scope of the invention. All such modifications and equivalents thereof are intended to be covered by the following claims.

What is claimed is:

1. A vent assembly for a transmission for an automotive vehicle powertrain, the transmission having a housing, rotary gearing in the housing, the rotary gearing defining power flow paths from a transmission power input shaft to a transmission power output shaft, a transmission fluid sump located below the rotary gearing and a transmission fluid pump connected driveably to the transmission power input shaft for delivering transmission fluid to the gearing, the vent assembly comprising:
a vent wall structure defining a dry cavity located within the transmission housing at a location above the transmission fluid sump;
a first vent port in the vent assembly;
a vent opening in the transmission housing communicating with atmosphere; and
a second vent port in the vent assembly spaced below the first vent port, the first vent port communicating with the vent opening in the transmission housing;
the second vent port communicating with an air and transmission fluid mixture within the transmission housing created by dynamic effects of the rotary gearing whereby transmission fluid separates from the air and transmission fluid mixture as the mixture enters the cavity;
air in the transmission air and fluid mixture being expelled through the first vent port to atmosphere as transmission fluid in the mixture drains through the second vent port to the interior of the transmission housing.

2. The vent assembly set forth in claim 1 wherein the vent assembly is secured to an internal stationary wall of the transmission housing.

3. The vent assembly set forth in claim 2 wherein the second vent port is elongated in a generally transverse direction relative to a rotary axis of the gearing whereby drainage of fluid from the dry cavity is accommodated as the air and transmission fluid mixture enters the dry cavity.

4. The vent assembly set forth in claim 3 wherein the internal stationary wall of the transmission housing is a bearing support wall, the gearing being journalled on the bearing support wall.

5. The vent assembly set forth in claim 4 wherein the vent assembly further comprises a thermoplastic molding with first and second vent housing parts that define the dry cavity, one vent housing part being located on one side of the bearing support wall and the second vent housing part being located on the opposite side of the bearing support wall;
the vent housing parts having interlocking elements for securing the vent housing parts in assembled relationship whereby the vent housing is held fast within the transmission housing.

6. A dry cavity assembly for an automatic transmission for an automotive vehicle powertrain, the transmission having a housing including a torque converter portion, rotary gearing in a gearing housing portion of the transmission housing, the gearing defining power flow paths from a transmission power input shaft to a transmission power output shaft, a transmission fluid sump located below the rotary gearing and a transmission fluid pump connected driveably to the transmission power input shaft for delivering transmission fluid to the gearing, the dry cavity assembly comprising:
a dry cavity wall structure located within the transmission gearing housing portion at a location above the transmission fluid sump, a first vent port in the dry cavity wall structure;
a vent opening in the transmission gearing housing portion;
a vent tube connected to the vent opening and extending to the interior of the torque converter housing portion, the torque converter housing portion pressure being generally atmospheric; and
a second vent port in the dry cavity wall structure spaced below the first vent port, the first vent port communicating with the vent opening in the transmission gearing housing portion;
the second vent port communicating with an air and transmission fluid mixture within the transmission housing created by dynamic effects of the rotary gearing whereby transmission fluid separates from the air and transmission fluid mixture as the mixture enters the dry cavity wall structure;
air in the transmission air and fluid mixture being expelled through the first vent port to the vent tube as transmission fluid in the mixture drains through the second vent port to the interior of the transmission gearing housing portion.

7. The dry cavity assembly set forth in claim 6 wherein the dry cavity wall structure is secured to an internal stationary wall of the transmission housing.

8. The dry cavity assembly set forth in claim 7 wherein the second vent port is elongated in a generally transverse direction relative to a rotary axis of the gearing whereby drainage of fluid from the dry cavity is accommodated as the air and transmission fluid mixture enters the dry cavity.

9. The dry cavity assembly set forth in claim 8 wherein the internal stationary wall of the transmission housing is a bearing support wall, the gearing being journalled on the bearing support wall.

10. The dry cavity assembly set forth in claim 9 wherein the dry cavity wall structure comprises a thermoplastic molding with first and second dry cavity parts, one cavity part being located on one side of the bearing support wall and the second cavity part being located on the opposite side of the bearing support wall;
the dry cavity parts being secured together in assembled relationship whereby the dry cavity assembly is held fast within the transmission housing.
